(19) United States
(12) Patent Application Publication
(10) Pub. No.: US 2023/0246728 A1
(43) Pub. Date: Aug. 3, 2023

(54) REACTIVE JAMMING DETECTION

(71) Applicant: Nokia Technologies Oy, Espoo (FI)

(72) Inventors: Paolo BARACCA, Munich (DE); Karthik UPADHYA, Espoo (FI); Saeed KHOSRAVIRAD, Mountainside, NJ (US); Tao TAO, Shanghai (CN); Lorenzo GALATI GIORDANO, Stuttgart (DE)

(21) Appl. No.: 18/002,826

(22) PCT Filed: Jun. 25, 2020
(86) PCT No.: PCT/CN2020/098301

§ 371 Date: Dec. 21, 2022

(51) Int. Cl. H04K 3/00

(52) U.S. Cl. CPC H04K 3/28; H04K 3/22; H04K 3/41; H04K 3/45

(57) ABSTRACT

Embodiments of the present disclosure relate to device, method, apparatus and computer readable storage media of reactive jamming detection. The method comprises in accordance with a determination that an interference to the first device is to be detected, determining at least one set of actual receiving powers at the first device on a bandwidth and a frequency of a channel associated with a transmission of the first device within a time interval; determining at least one set of reference receiving powers at the first device on the bandwidth and the frequency; and in accordance with a determination that a difference between the at least one set of reference receiving powers and the at least one set of actual receiving powers exceeds a threshold difference, determining the first device is interfered by reactive jamming. In this way, the malicious device that does not respect the LBT procedure in unlicensed bands can be recognized and meanwhile the devices using a different technology while respecting the LBT procedure can be allowed to access the channel.

### FIELD

Embodiments of the present disclosure generally relate to the field of telecommunication and in particular, to device, method, apparatus and computer readable storage media of reactive jamming detection.

### BACKGROUND

Radio jamming by a malicious device is a type of security attack that can threaten the performance of a communication system. In detail, a jammer is a malicious device that intentionally injects interference without necessarily transmitting any information, but just with the purpose of performing a “denial of service” attack.

There are different types of jammers, depending on their capabilities and cost, from basic devices that just transmit power on some narrow- or wide-bands to more advanced reactive devices. The reactive jammers stay quiet while the channel is inactive and starts transmitting as soon as they sense some transmission on the channel, even with the possibility of sending a signal in the format of a “regular” packet, i.e., a packet compliant with the standard used on that band.

### SUMMARY

In general, example embodiments of the present disclosure provide a solution of reactive jamming detection.

In a first aspect, there is provided a first device. The terminal device comprises at least one processor; and at least one memory including computer program codes; the at least one memory and the computer program codes are configured to, with the at least one processor, cause the first device at least to, in accordance with a determination that an interference to the first device is to be detected, determine at least one set of actual receiving powers at the first device on a bandwidth and a frequency of a channel associated with a transmission of the first device within a time interval; determine at least one set of reference receiving powers at the first device on the bandwidth and the frequency; and in accordance with a determination that a difference between the at least one set of reference receiving powers and the at least one set of actual receiving powers exceeds a threshold difference, determine the first device is interfered by reactive jamming.

In a second aspect, there is provided a method. The method comprises in accordance with a determination that an interference to the first device is to be detected, determining at least one set of actual receiving powers at the first device on a bandwidth and a frequency of a channel associated with a transmission of the first device within a time interval; determining at least one set of reference receiving powers at the first device on the bandwidth and the frequency; and in accordance with a determination that a difference between the at least one set of reference receiving powers and the at least one set of actual receiving powers exceeds a threshold difference, determining the first device is interfered by reactive jamming.

In a third aspect, there is provided an apparatus comprises means for in accordance with a determination that an interference to the first device is to be detected, determining at least one set of actual receiving powers at the first device on a bandwidth and a frequency of a channel associated with a transmission of the first device within a time interval; means for determining at least one set of reference receiving powers at the first device on the bandwidth and the frequency; and means for in accordance with a determination that a difference between the at least one set of reference receiving powers and the at least one set of actual receiving powers exceeds a threshold difference, determining the first device is interfered by reactive jamming.

In a fourth aspect, there is provided a computer readable medium having a computer program stored thereon which, when executed by at least one processor of a device, causes the device to carry out the method according to the second aspect.

Other features and advantages of the embodiments of the present disclosure will also be apparent from the following description of specific embodiments when read in conjunction with the accompanying drawings, which illustrate, by way of example, the principles of embodiments of the disclosure.

### BRIEF DESCRIPTION OF THE DRAWINGS

Embodiments of the disclosure are presented in the sense of examples and their advantages are explained in greater detail below, with reference to the accompanying drawings, where

FIG. 1 shows an example communication network 100 in which embodiments of the present disclosure can be implemented;

FIG. 2 shows a flowchart of an example method of reactive jamming detection according to some example embodiments of the present disclosure;

FIGS. 3A-3B show examples of receiving power in different scenarios according to some example embodiments of the present disclosure;

FIGS. 4A-4D show examples of receiving power in different scenarios according to some example embodiments of the present disclosure;

FIG. 5 shows a schematic signaling diagram illustrating a process of offline training with multiple nodes according to example embodiments of the present disclosure;

FIG. 6 shows a simplified block diagram of a device that is suitable for implementing example embodiments of the present disclosure; and

FIG. 7 shows a block diagram of an example computer readable medium in accordance with some embodiments of the present disclosure.

Throughout the drawings, the same or similar reference numerals represent the same or similar element.

### DETAILED DESCRIPTION

Principle of the present disclosure will now be described with reference to some example embodiments. It is to be understood that these embodiments are described only for the purpose of illustration and help those skilled in the art to understand and implement the present disclosure, without suggesting any limitation as to the scope of the disclosure. The disclosure described herein can be implemented in various manners other than the ones described below.

In the following description and claims, unless defined otherwise, all technical and scientific terms used herein have the same meaning as commonly understood by one of ordinary skills in the art to which this disclosure belongs.

References in the present disclosure to “one embodiment,” “an embodiment,” “an example embodiment,” and the like indicate that the embodiment described may include a particular feature, structure, or characteristic, but it is not necessary that every embodiment includes the particular feature, structure, or characteristic. Moreover, such phrases are not necessarily referring to the same embodiment. Further, when a particular feature, structure, or characteristic is described in connection with an example embodiment, it is submitted that it is within the knowledge of one skilled in the art to affect such feature, structure, or characteristic in connection with other embodiments whether or not explicitly described.

It shall be understood that although the terms “first” and “second” etc. may be used herein to describe various elements, these elements should not be limited by these terms. These terms are only used to distinguish functionalities of various elements. As used herein, the term “and/or” includes any and all combinations of one or more of the listed terms.

The terminology used herein is for the purpose of describing particular embodiments only and is not intended to be limiting of example embodiments. As used herein, the singular forms “a”, “an” and “the” are intended to include the plural forms as well, unless the context clearly indicates otherwise. It will be further understood that the terms “comprises”, “comprising”, “has”, “having”, “includes” and/or “including”, when used herein, specify the presence of stated features, elements, and/or components etc., but do not preclude the presence or addition of one or more other features, elements, components and/or combinations thereof.

As used in this application, the term “circuitry” may refer to one or more or all of the following:

(a) hardware-only circuit implementations (such as implementations in only analog and/or digital circuitry) and

(b) combinations of hardware circuits and software, such as (as applicable):
(i) a combination of analog and/or digital hardware circuit(s) with software/firmware and
(ii) any portions of hardware processor(s) with software (including digital signal processor(s)), software, and memory(ies) that work together to cause an apparatus, such as a mobile phone or server, to perform various functions) and

(c) hardware circuit(s) and or processor(s), such as a microprocessor(s) or a portion of a microprocessor(s), that requires software (e.g., firmware) for operation, but the software may not be present when it is not needed for operation.

This definition of circuitry applies to all uses of this term in this application, including in any claims. As a further example, as used in this application, the term circuitry also covers an implementation of merely a hardware circuit or processor (or multiple processors) or portion of a hardware circuit or processor and its (or their) accompanying software and/or firmware. The term circuitry also covers, for example and if applicable to the particular claim element, a baseband integrated circuit or processor integrated circuit for a mobile device or a similar integrated circuit in server, a cellular network device, or other computing or network device.

As used herein, the term “communication network” refers to a network following any suitable communication standards, such as fifth generation (5G) systems, Long Term Evolution (LTE), LTE-Advanced (LTE-A), Wideband Code Division Multiple Access (WCDMA), High-Speed Packet Access (HSPA), Narrow Band Internet of Things (NB-IoT) and so on. Furthermore, the communications between a terminal device and a network device in the communication network may be performed according to any suitable generation communication protocols, including, but not limited to, the first generation (1G), the second generation (2G), 2.5G, 2.75G, the third generation (3G), the fourth generation (4G), 4.5G, the future fifth generation (5G) new radio (NR) communication protocols, and/or any other protocols either currently known or to be developed in the future. Embodiments of the present disclosure may be applied in various communication systems. Given the rapid development in communications, there will of course also be future type communication technologies and systems with which the present disclosure may be embodied. It should not be seen as limiting the scope of the present disclosure to only the aforementioned system.

As used herein, the term “network device” refers to a node in a communication network via which a terminal device accesses the network and receives services therefrom. The network device may refer to a base station (BS) or an access point (AP), for example, a node B (NodeB or NB), an evolved NodeB (eNodeB or eNB), a NR Next Generation NodeB (gNB), a Remote Radio Unit (RRU), a radio header (RH), a remote radio head (RRH), a relay, a low power node such as a femto, a pico, and so forth, depending on the applied terminology and technology. A RAN split architecture comprises a gNB-CU (Centralized unit, hosting RRC, SDAP and PDCP) controlling a plurality of gNB-DUs (Distributed unit, hosting RLC, MAC and PHY). A relay node may correspond to DU part of the IAB node.

The term “terminal device” refers to any end device that may be capable of wireless communication. By way of example rather than limitation, a terminal device may also be referred to as a communication device, user equipment (UE), a Subscriber Station (SS), a Portable Subscriber Station, a Mobile Station (MS), or an Access Terminal (AT). The terminal device may include, but not limited to, a mobile phone, a cellular phone, a smart phone, voice over IP (VoIP) phones, wireless local loop phones, a tablet, a wearable terminal device, a personal digital assistant (PDA), portable computers, desktop computer, image capture terminal devices such as digital cameras, gaming terminal devices, music storage and playback appliances, vehicle-mounted wireless terminal devices, wireless endpoints, mobile stations, laptop-embedded equipment (LEE), laptop-mounted equipment (LME), USB dongles, smart devices, wireless customer-premises equipment (CPE), an Internet of Things (IoT) device, a watch or other wearable, a head-mounted display (HMD), a vehicle, a drone, a medical device and applications (e.g., remote surgery), an industrial device and applications (e.g., a robot and/or other wireless devices operating in an industrial and/or an automated processing chain contexts), a consumer electronics device, a device operating on commercial and/or industrial wireless networks, and the like. The terminal device may also correspond to Mobile Termination (MT) part of the integrated access and backhaul (IAB) node (a.k.a. a relay node). In the following description, the terms “terminal device”, “communication device”, “terminal”, “user equipment” and “UE” may be used interchangeably.

Although functionalities described herein can be performed, in various example embodiments, in a fixed and/or a wireless network node, in other example embodiments, functionalities may be implemented in a user equipment apparatus (such as a cell phone or tablet computer or laptop computer or desktop computer or mobile IoT device or fixed IoT device). This user equipment apparatus can, for example, be furnished with corresponding capabilities as described in connection with the fixed and/or the wireless network node(s), as appropriate. The user equipment apparatus may be the user equipment and/or or a control device, such as a chipset or processor, configured to control the user equipment when installed therein. Examples of such functionalities include the bootstrapping server function and/or the home subscriber server, which may be implemented in the user equipment apparatus by providing the user equipment apparatus with software configured to cause the user equipment apparatus to perform from the point of view of these functions/nodes.

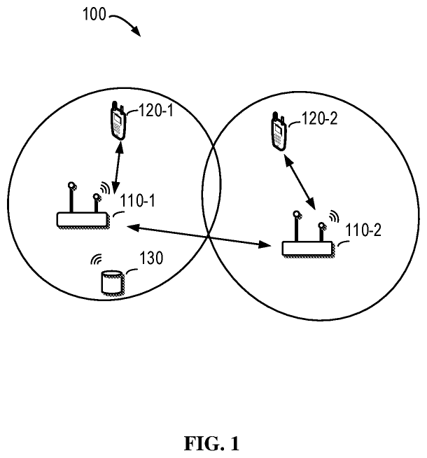

FIG. 1 shows an example communication network 100 in which embodiments of the present disclosure can be implemented. As shown in FIG. 1, the communication network 100 comprises a first Access Point (AP) 110-1 (hereafter also referred to as a first device 110-1) and a first terminal device 120-1 (hereafter also referred to as a first UE 120-1). The first AP 110-1 may communicate with the UE 120-1. The communication network 100 also comprises a second Access Point (AP) 110-2 (hereafter also referred to as a second device 110-2) and a second terminal device 120-2 (hereafter also referred to as a second UE 120-2). The second AP 110-2 may communicate with the UE 120-2. The first AP 110-1 may also communicate with the second AP 110-2. It is to be understood that the number of APs and terminal devices shown in FIG. 1 is given for the purpose of illustration without suggesting any limitations. The communication network 100 may include any suitable number of APs and terminal devices.

In the communication network 100 shown in FIG. 1, there is a jammer 130, which can be considered as a malicious device located in the coverage of the first AP 110-1. The jammer may interfere, for example, the transmission between the first AP 110-1 and the first UE 120-1.

As described above, radio jamming by a malicious device is a type of security attack that can threaten the performance of a communication system. In detail, a jammer is a malicious device that intentionally injects interference without necessarily transmitting any information, but just with the purpose of performing a “denial of service” attack.

There are different types of jammers, depending on their capabilities and cost, from basic devices that just transmit power on some narrow- or wide-bands to more advanced reactive devices. The reactive jammers stay quiet while the channel is inactive and starts transmitting as soon as they sense some transmission on the channel, even with the possibility of sending a signal in the format of a “regular” packet, i.e., a packet compliant with the standard used on that band.

Jamming is a rather old topic and has been studied and used for many years, for instance in the military context to degrade the effectiveness of enemy radars. Mainly because of that, getting a jammer that works with relative high power (40 dBm and more) in bands used by mobile communications (2G-3G-4G-5G, WiFi, Bluetooth) and positioning (GPS, Glonass) systems is rather simple and cheap.

Regarding security, both LTE and NR have defined several security functionalities such as authentication, privacy and data integrity. The authentication can be handled in the core network, to ensure protection to confirm UE identities, i.e., against attackers that try to send data while claiming to be a different device. The privacy can be handled at the Packet data convergence protocol (PDCP) layer, to ensure protection of data against eavesdropping, mainly obtained through ciphering/encryption. Furthermore, the data integrity can be handled at the PDCP layer, to ensure protection against attacks that alter the data sent by a source to a destination.

Although there exists no security scheme implemented at the physical layer, all these mechanisms make both Long Term Evolution (LTE) and New Radio (NR) very secure mobile communications standards.

However, as 5G is deployed for factory automation, it might happen that a jammer, stationed outside the plant, is active and blocks the transmission of some legitimate devices inside the plant. As the reliability and availability requirements of the industrial use cases are rather extreme, the sensitivity of the system for not being able to deliver sufficient service quality is also high even when moderate levels of jamming are used. The factory owner can face huge economic losses if those attacks eventually succeed in pausing the production.

Besides industrial automation, an active jammer might have a very negative effect for several 5G use cases characterized by ultra-reliable low-latency communications (URLLC) such as smart transportation and remote healthcare. For the smart transportation, jammers must be properly handled if we want to deploy autonomous driving and guarantee road safety. For the remote healthcare, remote monitoring of patients which require automatic responses might be blocked by jammers, with therefore a negative effect on people's health.

There is a significant difference between a legitimate interfering device and a jammer. A legitimate device is creating interference anyhow respecting the standard (LTE, NR, WiFi, . . . ) rules (timing, power, scheduling, listen-before-talk (LBT) procedures, . . . ), and a lot of well-known techniques exist to deal with that type of interference, while a jammer is a malicious device that intentionally attacks the system also violating the standard rules, and its activity can be extremely dangerous: smart jamming attacks can bring a network down even with a small jamming activity.

It is fundamental to detect the presence of a jammer when active, and, in particular, it is important to understand that some network performance degradation happens because of a malicious jamming attack and not because of fading or some legitimate cellular interference. When a jammer is detected, it is then important to characterize its activity as much as possible.

Then mitigation techniques need to be applied in order to limit the jammer. Various approaches for mitigating the jammer have been proposed. For example, direct sequence spread spectrum, by signal spreading and de-spreading; frequency hopping spread spectrum, by hopping carrier on the system band; beamforming, by applying weights at the antennas to steer beams in proper direction; power control, by increasing the transmit power and link adaptation, by using more robust quadrature amplitude modulation (QAM) constellation sizes and coding schemes.

Recently, the discussion of the detection problem of a reactive jammer in networks operating in unlicensed bands, i.e., NR-U and WiFi, has become of interest. Furthermore, assuming that the jammer is to be reactive, which is the most challenging scenario poses new challenges to the detection due to its more dynamic and difficult to predict effects. The unlicensed bands appear to be particularly challenging for jamming detection simply because they are not licensed bands: anybody is allowed transmitting at those frequencies. In fact, many diverse technologies are using them besides NR-U and WiFi, for instance (but not only) Bluetooth or Zigbee.

In order to limit the interference in the unlicensed bands generated both by devices using the same technology and by devices using different technologies, the LBT may be accepted as the main process in most of the countries for that. Generally, in the LBT procedure, a device senses the channel in order to determine whether there is signal above a certain Clear Channel Assessment (CCA) threshold. If a signal is detected, the device postpones its transmission to a later moment when the channel will be free again. If a signal is not detected, the device starts transmitting, thus occupying the channel for a limited amount of time.

Detecting basic non-reactive jammers that can be either wideband or narrowband and either be always active or alternate jamming signals to sleeping periods is rather easy, for instance monitoring basic statistics like the “received signal strength” or the “carrier sensing time.” However, these simple techniques do not work with reactive jammers, and more advanced techniques in that case need to combine several statistics. However, such techniques can not distinguish whether a “potential” jamming device followed or not the LBT, and that is key in unlicensed bands.

Therefore, the solution of the present invention proposes an idea to detect reactive jammers operating in unlicensed bands that do not follow the LBT procedure. For example, in this solution, when an LBT procedure has been performed at an access point and the access point has successfully accessed to a channel, the access point may measure receiving powers at the access point at a specific frequency and bandwidth of the channel. The access point may compare the measured receiving powers and reference receiving powers, which may be determined in a certain condition, and detect whether the reactive jammer exists based on the comparison. In this way, the malicious device that does not respect the LBT procedure in unlicensed bands can be recognized and meanwhile the devices using a different technology while respecting the LBT procedure can be allowed to access the channel.

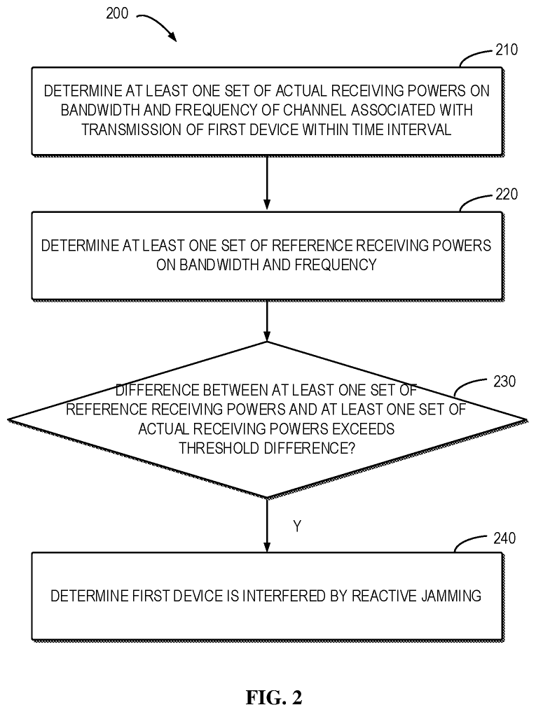

Principle and implementations of the present disclosure will be described in detail below with reference to FIGS. 2-5. FIG. 2 shows a flowchart of an example method 200 of reactive jamming detection according to some example embodiments of the present disclosure. The method 200 can be implemented at the first AP 110-1 as shown in FIG. 1. For the purpose of discussion, the method 200 will be described with reference to FIG. 1.

In the solution of the present invention, the first AP 110-1 can be equipped with a further antenna or a further antenna array used for reception on the same band/channel. Besides this physical antenna separation, the first AP 110-1 still needs some further isolation obtained with RF analog filtering and/or baseband processing.

In some conditions, the first AP 110-1 may trigger a detection procedure to determine whether there is an interference against the transmission of the first AP 110-1. For example, the detection may be performed at regular time interval when the first AP 110-1 is performing a transmission.

As an option, the detection may be triggered when an acknowledge or not acknowledge feedback is received at the first AP 110-1.

As another option, the detection may also be triggered if the first AP 110-1 fails to receive an acknowledge or not acknowledge feedback in a time period after a transmission is initiated.

Furthermore, to access a channel for a transmission, for example, for initiating a transmission from the first AP 110-1 to the first UE 120-1, an LBT procedure can be performed at the first AP 110-1. If the LBT procedure fails, the first AP 110-1 may also trigger the detection procedure.

As shown in FIG. 2, at 210, if the first AP 110-1 determines an interference to the first AP 110-1 is to be detected, the first AP 110-1 may determine at least one set of actual receiving powers at the first AP 110-1 on a bandwidth and a frequency of a channel associated with the first device within a time interval.

For example, after the first AP 110-1 successfully performs LBT and gets access to the channel, the first AP 110-1 may monitor the instantaneous receive power Pₜ at time t=0, 1, . . . , T−1, and store the instantaneous receive power Pₜ in P=[P₀, P₁, . . . , P_{T-1}].

In order to determine whether there is a reactive jamming interfering the transmission of the first AP 110-1 on the channel within the time interval, at least one set reference receiving powers can be determined in some specific conditions in an offline training procedure for recognizing the jamming.

At 220, the first AP 110-1 determines at least one set of reference receiving powers at the first AP 110-1 on the bandwidth and the frequency of the channel associated with a transmission of the first device. As mention above, the at least one set of reference receiving powers can be determined in some specific conditions in an offline training procedure. For example, the at least one set of reference receiving powers can be represented as a set of reference receiving power curves P^{(ref)}.

For example, an offline training of the first AP 110-1 can be performed in an environment without any jammer. It is also possible that the offline training of the first AP 110-1 can be performed when a second AP 110-2 and a second UE 120-2 that respect the LBT are sharing the same channel with the first AP 110-1.

As mentioned above, the first AP 110-1 can be equipped with a further antenna or a further antenna array used for reception on the same band/channel. It is to be understood that such full-duplex communications require having a very high isolation between Tx and Rx branches, such that the impact of the self-interference (SI) power at the Rx branch is comparable or lower than the thermal noise power. However, the required isolation needed here is lower because the AP does not need to decode any signal, it just needs to detect whether, on top of its own transmission, there is also a jamming signal.

For example, in order to obtain at least one set of measured receiving powers related to the self-interference of the first AP 110-1, the offline training can be performed in an anechoic chamber. This setup allows to properly characterize the SI at the first AP 110-1 without the reflections caused by the environment, i.e., the SI just caused by the direct link between Tx and Rx branches at the first AP 110-1.

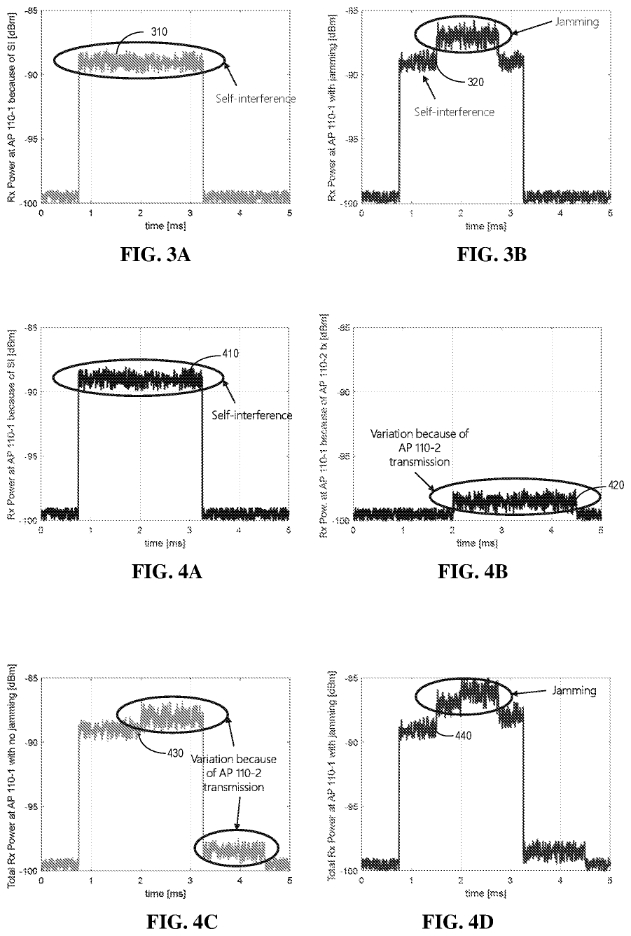

In the offline training, the first AP 110-1, can typically operate at different carrier frequencies f and with different bandwidths B, thus several reference curves of the expected receive power can be generated. That is, the outcome of this offline training is a plurality of expected receive power curves, each curve being a function of f and B. FIGS. 3A-3B show examples of receiving power in different scenarios according to some example embodiments of the present disclosure. An example of the expected receiving power curve 310 can be shown in FIG. 3A.

At least one set of measured receiving powers corresponding to the bandwidth and frequency of a channel associated with a transmission of the first device, as described above, can be selected from the plurality of expected receive power curves and determined as at least one set of reference receiving powers.

In some example embodiments, if the first AP 110-1 determines there is no transmission initiated from the second AP 110-2, the first AP 110-1 may determine at least one set of measured receiving powers related to the self-interference of the first AP 110-1 as the at least one set of reference receiving powers.

As mentioned above, the offline training of the first AP 110-1 can also be performed when a second AP 110-2 and a second UE 120-2 that respect the LBT are sharing the same channel with the first AP 110-1.

The LBT allows the neighbouring APs and UEs to share in a fair way the same channel. Two devices can access the channel at the same time only if the wireless link between them is weak enough, specifically only if the interference power generated by a device to the other device is below the CCA threshold. That interference may be stronger than the thermal noise, but not strong enough to severely affect the signal decoding performance.

In this offline training procedure, the first AP 110-1 can perform a transmission toward the first UE 120-1, and the second AP 110-2 can perform a further transmission toward the second UE 120-2. Meanwhile the first AP 110-1 and the second AP 110-2 are far enough such that they can both access the channel at the same time while generating a small interference power that is anyhow stronger than the thermal noise power.

FIGS. 4A-4D show examples of receiving power in different scenarios according to some example embodiments of the present disclosure.

If only the first AP 110-1 performs a transmission toward the first UE 120-1, at least one set of measured receiving powers of the first AP 110-1 related to the self-interference of the first AP 110-1 can be determined. An example of the receiving power curve 410 can be shown in FIG. 4A. If only the second AP 110-2 performs a further transmission toward the second UE 120-s, at least one set of measured receiving powers of the first AP 110-1 related to the further transmission of the second AP 110-2 can be determined. An example of the receiving power curve 420 can be shown in FIG. 4B. If both the first AP 110-1 and the second AP 110-2 perform a transmission respectively, the receiving power at the first AP 110-1 may be interfered by the transmission of the second AP 110-2. The receiving power curve 430 can be shown in FIG. 4C.

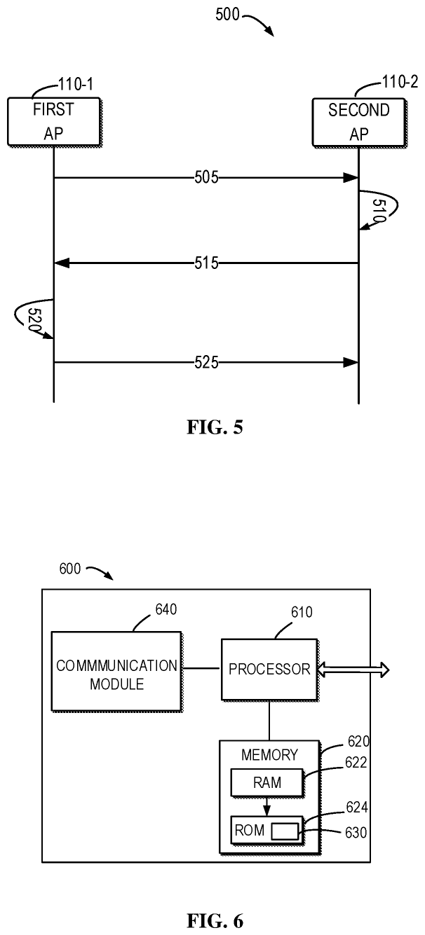

In the example of FIG. 4C, the variation happens because of the legitimate transmission of the second AP 110-2 and therefore this type of variation should be avoided as malicious interference, i.e., jamming. To perform the offline training procedure more accurately, some information exchange among the first AP 110-1 and the second AP 110-2 via a backhaul network may be required. FIG. 5 shows a schematic signaling diagram illustrating a process of offline training with multiple nodes according to example embodiments of the present disclosure.

In NR-U, this information exchange among the first AP 110-1 and the second AP 110-2 can be done via the Xn interface, while in WiFi, although there is no high-speed backhaul connecting the first AP 110-1 and the second AP 110-2, there is an Ethernet based backhaul that can be used by the first AP 110-1 and the second AP 110-2 to share such information.

As shown in FIG. 5, the first AP 110-1 may transmit via backhaul 505, to the second AP 110-2, an indication for triggering a further transmission initiated from the second AP 110-2 and start monitoring the time evolution of the receiving power at the first AP 110-1. Then the second AP 110-2 may perform 510 the further transmission on the wireless channel, for example, a transmission from the second AP 110-2 to the second UE 120-2. As this 510 transmission on the wireless channel can also be jammed, the AP 110-1 may need to implement some jamming detection also for this transmission, for instance by using the scheme in FIG. 2 with reference receiving power just the one associated with the self-interference of AP 110-1. When the second AP 110-2 performs the further transmission, the second AP 110-2 may transmit via backhaul 515 the starting time t_{APj} and duration D_{APj} of the transmission initiated from the second AP 110-2 to the first AP 110-1.

Then the first AP 110-1 determine the receiving power at the first AP 110-1 during the transmission on the wireless channel of the second AP 110-2 and check 520 if the interference generated by second AP 110-2 is above the thermal noise power but below the CCA threshold. The first AP 110-1 may transmit via backhaul 525 the comparison result between the receiving power at the first AP 110-1 and the thermal noise power and the CCA threshold to the second AP 110-2. For example, if the receiving power at the first AP 110-1 is in a range between the thermal noise power and the CCA threshold, the first AP 110-1 may transmit one bit with “1”, while if the receiving power at the first AP 110-1 is below the thermal noise power, the first AP 110-1 may transmit one bit with “0”. If the interference generated by second AP 110-2 is above the thermal noise power but below the CCA threshold, the first AP 110-1 may store the interference power P^{(APj)} generated by second AP 110-2 and the second AP 110-2 will forward via backhaul t_{APj} and D_{APj} for any upcoming transmission.

For example, the first AP 110-1 equipped with jamming detection capabilities may repeat the process shown in FIG. 5 for any neighbouring APs before starting operations. After that, the first AP 110-1 may construct a set of interference power P^{(APj)} associated with neighbouring APs of the first AP 110-1 whose transmission generates interference above the noise power and below the CCA threshold. In this way, by means of this offline training, a reference receiving power associated with the self-interference of the first AP 110-1 and a further reference receiving power associated with the transmission of the second AP 110-2 may be determined.

It is possible that when the first AP 110-1 measures the receiving power at the first AP 110-1 within a time interval in the offline training, the first AP 110-1 is not aware of a transmission of a neighbouring AP, for example, of the second AP 110-2. Then if the first AP 110-1 receives, from the second AP 110-2, an indication that the transmission of the second AP 110-2 is performed at this time interval, the first AP 110-1 may determine the measured receiving power as the receiving power related to the transmission initiated from the second AP 110-2.

Therefore, in some example embodiments, in a case where the first AP 110-1 determines there is a transmission initiated from the second AP 110-2, the first AP 110-1 may determine at least one first set of measured receiving power of the first AP 110-1 related to the transmission initiated from the second AP 110-2 and at least one second set of measured receiving powers of the first AP 110-1 related to the self-interference of the first AP 110-1 and determine the at least one set of reference receiving powers based on the at least one first set of measured receiving powers and the at least one second set of measured receiving powers.

Referring back to FIG. 2, at 230, the first AP 110-1 determines whether a difference exists between the at least one set of reference receiving powers and the at least one set of actual receiving powers exceeds a threshold difference. If the first AP 110-1 determines that the difference between the at least one set of reference receiving powers and the at least one set of actual receiving powers exceeds a threshold difference, at 240, the first AP 110-1 determines the first AP 110-1 is interfered by reactive jamming.

As mentioned above, if there is no active neighbouring AP, the at least one set of actual receiving powers P of the first AP 110-1 may compare with the at least one set of measured receiving powers P^{(ref)} related to the self-interference of the first AP 110-1. If there is an active neighbouring AP, the at least one set of actual receiving powers P of the first AP 110-1 may compare with a reference receiving power P_{MN}^{(ref)} associated with at least one set of measured receiving powers P^{(ref)} related to the self-interference of the first AP 110-1 and at least one first set of measured receiving power P^{(APj)} of the first AP 110-1 related to the transmission initiated from the second AP 110-2.

The difference between the at least one set of reference receiving powers and the at least one set of actual receiving powers can be represented as a distance between the curves of the at least one set of reference receiving powers and the curves of the at least one set of actual receiving powers.

If the at least one set of actual receiving powers comprises a set of actual receiving powers and the at least one set of reference receiving powers comprises a set of reference receiving powers, for example, the Euclidean distance between the curve of the set of actual receiving powers and the curve of the set of reference receiving powers can be determined as the difference.

It is also possible to use different metrics to cope with potential different attacks from the jammer. For example, as the jammer might have an impulsive behaviour, for instance being active for a short time, the Chebyshev distance between the curve of the set of actual receiving powers and the curve of the set of reference receiving powers can be determined as the difference. Furthermore, as the jammer might perform a narrowband attack, it is necessary to compare the set of reference receiving powers and the set of actual receiving powers as well in the frequency domain.

For example, when the first AP 110-1 is equipped with multiple additional receive antennas and in that case both reference receiving powers and actual receiving powers are two set of sequences, a spatial characterization of the interfering signals is also possible and must be implemented.

After determining the difference between the at least one set of reference receiving powers and the at least one set of actual receiving powers, the first AP 110-1 can compare the difference with a predefined test threshold γ. If the distance is above that threshold, the first AP 110-1 may determine a jammer is active. The examples of the receiving power at the AP 110-1 interfered by the active jammer can be shown in FIG. 3B and FIG. 4D with curves 320 and 440, respectively.

For example, the test threshold γ may be a function of at least four parameters including noise floor, Tx-Rx isolation at the first AP 110-1, CCA threshold, and target false alarm probability and may be defined at the first AP 110-1 by using a generalized likelihood ratio test.

In some example embodiments, if the first AP 110-1 determines that the difference between the at least one set of reference receiving powers and the at least one set of actual receiving powers is below a threshold difference, the first AP 110-1 may update the at least one set of reference receiving powers based on the at least one set of actual receiving powers.

For example, a reference curve P^{(ref)} can be generated offline in a jamming-free scenario, for instance in an anechoic chamber. When a successful transmission (a.k.a. jamming-free), i.e., when d(P, P^{(ref)})<γ is obtained, the reference curve P^{(ref)} can be improved by updating it with the actual receiving power P.

For example, basic maths tools can be used for this update, for instance a moving average like:

P^{(ref)}(k+1)=(1−ω)P^{(ref)}(k)+ωP(k) (1)

with k being the index of the packet transmission, ω a parameter close to 0, and given d(P(k), P^{(ref)}(k))<γ, i.e., by applying this update only when no jammer was detected.

As described above, the solution proposes an idea to detect reactive jammers operating in unlicensed bands that do not follow the LBT procedure. In this way, the malicious device that does not respect the LBT procedure in unlicensed bands can be recognized and meanwhile the devices using a different technology while respecting the LBT procedure can be allowed to access the channel.

In some example embodiments, an apparatus capable of performing the method 200 (for example, implemented at the first AP 110-1) may comprise means for performing the respective steps of the method 200. The means may be implemented in any suitable form. For example, the means may be implemented in a circuitry or software module.

In some example embodiments, the apparatus comprises means for in accordance with a determination that an interference to the first device is to be detected, determining at least one set of actual receiving powers at the first device on a bandwidth and a frequency of a channel associated with a transmission of the first device within a time interval; means for determining at least one set of reference receiving powers at the first device on the bandwidth and the frequency; and means for in accordance with a determination that a difference between the at least one set of reference receiving powers and the at least one set of actual receiving powers exceeds a threshold difference, determining the first device is interfered by reactive jamming.

FIG. 6 is a simplified block diagram of a device 600 that is suitable for implementing embodiments of the present disclosure. The device 600 may be provided to implement the communication device, for example first AP 110-1 as shown in FIG. 1. As shown, the device 600 includes one or more processors 610, one or more memories 620 coupled to the processor 610, and one or more transmitters and/or receivers (TX/RX) 640 coupled to the processor 610.

The TX/RX 640 is for bidirectional communications. The TX/RX 640 has at least one antenna to facilitate communication. The communication interface may represent any interface that is necessary for communication with other network elements.

The processor 610 may be of any type suitable to the local technical network and may include one or more of the following: general purpose computers, special purpose computers, microprocessors, digital signal processors (DSPs) and processors based on multicore processor architecture, as non-limiting examples. The device 600 may have multiple processors, such as an application specific integrated circuit chip that is slaved in time to a clock which synchronizes the main processor.

The memory 620 may include one or more non-volatile memories and one or more volatile memories. Examples of the non-volatile memories include, but are not limited to, a Read Only Memory (ROM) 624, an electrically programmable read only memory (EPROM), a flash memory, a hard disk, a compact disc (CD), a digital video disk (DVD), and other magnetic storage and/or optical storage. Examples of the volatile memories include, but are not limited to, a random access memory (RAM) 622 and other volatile memories that will not last in the power-down duration.

A computer program 630 includes computer executable instructions that are executed by the associated processor 610. The program 630 may be stored in the ROM 620. The processor 610 may perform any suitable actions and processing by loading the program 630 into the RAM 620.

The embodiments of the present disclosure may be implemented by means of the program 630 so that the device 600 may perform any process of the disclosure as discussed with reference to FIGS. 2 to 5. The embodiments of the present disclosure may also be implemented by hardware or by a combination of software and hardware.

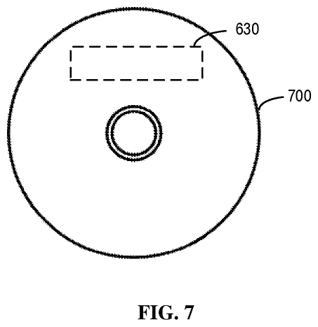

In some embodiments, the program 630 may be tangibly contained in a computer readable medium which may be included in the device 600 (such as in the memory 620) or other storage devices that are accessible by the device 600. The device 600 may load the program 630 from the computer readable medium to the RAM 622 for execution. The computer readable medium may include any types of tangible non-volatile storage, such as ROM, EPROM, a flash memory, a hard disk, CD, DVD, and the like. FIG. 7 shows an example of the computer readable medium 700 in form of CD or DVD. The computer readable medium has the program 630 stored thereon.

Generally, various embodiments of the present disclosure may be implemented in hardware or special purpose circuits, software, logic or any combination thereof. Some aspects may be implemented in hardware, while other aspects may be implemented in firmware or software which may be executed by a controller, microprocessor or other computing device. While various aspects of embodiments of the present disclosure are illustrated and described as block diagrams, flowcharts, or using some other pictorial representations, it is to be understood that the block, device, system, technique or method described herein may be implemented in, as non-limiting examples, hardware, software, firmware, special purpose circuits or logic, general purpose hardware or controller or other computing devices, or some combination thereof.

The present disclosure also provides at least one computer program product tangibly stored on a non-transitory computer readable storage medium. The computer program product includes computer-executable instructions, such as those included in program modules, being executed in a device on a target real or virtual processor, to carry out the method 200 as described above with reference to FIG. 2. Generally, program modules include routines, programs, libraries, objects, classes, components, data structures, or the like that perform particular tasks or implement particular abstract data types. The functionality of the program modules may be combined or split between program modules as desired in various embodiments. Machine-executable instructions for program modules may be executed within a local or distributed device. In a distributed device, program modules may be located in both local and remote storage media.

Program code for carrying out methods of the present disclosure may be written in any combination of one or more programming languages. These program codes may be provided to a processor or controller of a general purpose computer, special purpose computer, or other programmable data processing device, such that the program codes, when executed by the processor or controller, cause the functions/operations specified in the flowcharts and/or block diagrams to be implemented. The program code may execute entirely on a machine, partly on the machine, as a stand-alone software package, partly on the machine and partly on a remote machine or entirely on the remote machine or server.

In the context of the present disclosure, the computer program codes or related data may be carried by any suitable carrier to enable the device, device or processor to perform various processes and operations as described above. Examples of the carrier include a signal, computer readable medium, and the like.

The computer readable medium may be a computer readable signal medium or a computer readable storage medium. A computer readable medium may include but not limited to an electronic, magnetic, optical, electromagnetic, infrared, or semiconductor system, device, or device, or any suitable combination of the foregoing. More specific examples of the computer readable storage medium would include an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing.

Further, while operations are depicted in a particular order, this should not be understood as requiring that such operations be performed in the particular order shown or in sequential order, or that all illustrated operations be performed, to achieve desirable results. In certain circumstances, multitasking and parallel processing may be advantageous. Likewise, while several specific implementation details are contained in the above discussions, these should not be construed as limitations on the scope of the present disclosure, but rather as descriptions of features that may be specific to particular embodiments. Certain features that are described in the context of separate embodiments may also be implemented in combination in a single embodiment. Conversely, various features that are described in the context of a single embodiment may also be implemented in multiple embodiments separately or in any suitable sub-combination.

Although the present disclosure has been described in languages specific to structural features and/or methodological acts, it is to be understood that the present disclosure defined in the appended claims is not necessarily limited to the specific features or acts described above. Rather, the specific features and acts described above are disclosed as example forms of implementing the claims.

1-22. (canceled)

23. A first device comprising:
at least one processor; and
at least one memory including computer program codes;
the at least one memory and the computer program codes are configured to, with the at least one processor, cause the first device at least to:
in accordance with a determination that an interference to the first device is to be detected, determine at least one set of actual receiving powers at the first device on a bandwidth and a frequency of a channel associated with a transmission of the first device within a time interval;
determine at least one set of reference receiving powers at the first device on the bandwidth and the frequency; and
in accordance with a determination that a difference between the at least one set of reference receiving powers and the at least one set of actual receiving powers exceeds a threshold difference, determine the first device is interfered by reactive jamming,
wherein the first device is caused to determine the at least one set of reference receiving powers by:
in accordance with a determination that there is a further transmission initiated from a second device within the time interval, determining at least one first set of measured receiving powers of the first device related to the further transmission;
determining at least one second set of measured receiving powers of the first device related to the self-interference of the first device; and
determining the at least one set of reference receiving powers based on the at least one first set of measured receiving powers and the at least one second set of measured receiving powers.

24. The first device of claim 23, wherein the first device is further cause to:
determine that the interference to the first device is to be detected, in accordance with a determination of at least one of the following:
the transmission is initiated from the first device;
an acknowledge or not acknowledge feedback for a previous transmission on the channel is received;
an acknowledge or not acknowledge feedback for a previous transmission on the channel fails to be received in a time period; and
a Listen Before Talk procedure for a previous transmission on the channel fails.

25. The first device of claim 23, wherein the first device is caused to determine the at least one set of reference receiving powers by:
in accordance with a determination that a further transmission fails to be initiated from a second device within the time interval, determining at least one set of measured receiving powers related to the self-interference of the first device; and
determining the at least one set of measured receiving powers as the at least one set of reference receiving powers.

26. The first device of claim 23, wherein the first device is further caused to:
transmit, to the second device, an indication for triggering a reference transmission initiated from the second device; and
receive an indication of a further time interval of the reference transmission from the second device;
determine at least one set of interfered receiving powers associated with the reference transmission within the further time interval; and
in accordance with a determination that the at least one set of receiving powers is in a range between thermal noise power and a clear channel assessment threshold, determine the at least one set of interfered receiving powers as the at least one first set of measured receiving powers.

27. The first device of claim 23, wherein the first device is further caused to:
measure at least one further set of reference receiving powers at the first device in a further time interval; and
in response to receiving, from the second device, an indication that a reference transmission initiated from the second device is performed within the further time interval via a backhaul between the first device and the second device, determine the at least one further set of reference receiving powers as the at least one first set of measured receiving powers.

28. The first device of claim 23, wherein the first device is further caused to:
in accordance with a determination that the difference between the at least one set of reference receiving powers and the at least one set of actual receiving powers is below a threshold difference, update the at least one set of reference receiving powers based on the at least one set of actual receiving powers.

29. The first device of claim 23, wherein the at least one set of reference receiving powers comprise a set of reference receiving powers and the at least one set of actual receiving powers comprise a set of actual receiving powers, and wherein the first device is further caused to:
generate a first curve based on the set of reference receiving powers;
generate a second curve based on the set of actual receiving powers;
determine at least one of the following as the difference:
a Euclidean distance between the first curve and the second curve;
a Chebyshev distance between the first curve and the second curve; and
a distance between the first curve and the second curve in a frequency domain.

30. The first device of claim 23, wherein the at least one set of reference receiving powers comprise a set of reference receiving powers and a further set of reference receiving powers and the at least one set of actual receiving powers comprise a set of actual receiving powers and a further set of actual receiving powers, and wherein the first device is further caused to:
generate a first set of curves based on the set of reference receiving powers and the further set of reference receiving powers;
generate a second set of curves based on the set of actual receiving powers and the further set of actual receiving powers; and
determine a spatial distance between the first set of curves and the second set of curves as the difference.

31. The first device of claim 23, wherein the first device comprises an access point, and a second device comprises a further access point.

32. A method comprising:
in accordance with a determination that an interference to the first device is to be detected, determining at least one set of actual receiving powers at the first device on a bandwidth and a frequency of a channel associated with a transmission of the first device within a time interval;
determining at least one set of reference receiving powers at the first device on the bandwidth and the frequency; and
in accordance with a determination that a difference between the at least one set of reference receiving powers and the at least one set of actual receiving powers exceeds a threshold difference, determining the first device is interfered by reactive jamming,
wherein determining at least one set of reference receiving powers comprises:
in accordance with a determination that there is a further transmission initiated from a second device within the time interval, determining at least one first set of measured receiving powers of the first device related to the further transmission;
determining at least one second set of measured receiving powers of the first device related to the self-interference of the first device; and
determining the at least one set of reference receiving powers based on the at least one first set of measured receiving powers and the at least one second set of measured receiving powers.

33. The method of claim 32, further comprising:
determining that the interference to the first device is to be detected, in accordance with a determination of at least one of the following:
the transmission on the channel is initiated from the first device;
an acknowledge or not acknowledge feedback for a previous transmission on the channel is received;
an acknowledge or not acknowledge feedback for a previous transmission on the channel fails to be received in a time period; and
a Listen Before Talk procedure for a previous transmission on the channel fails.

34. The method of claim 32, wherein determining at least one set of reference receiving powers comprises:
in accordance with a determination that a further transmission fails to be initiated from a second device within the time interval, determining the at least one set of measured receiving powers related to the self-interference of the first device; and
determining the at least one set of measured receiving powers as the at least one set of reference receiving powers.

35. The method of claim 32, further comprising:
transmitting, to a second device, an indication for triggering a reference transmission initiated from the second device; and
receiving an indication of a further time interval of the reference transmission from the second device;
measuring at least one set of interfered receiving powers associated with the reference transmission within the further time interval; and
in accordance with a determination that the at least one set of receiving powers is in a range between thermal noise power and a clear channel assessment threshold, determining the at least one set of receiving powers as the at least one first set of measured receiving powers.

36. The method of claim 32, further comprising:
measuring at least one further set of reference receiving powers at the first device in a further time interval; and
in response to receiving, from the second device, an indication that a reference transmission initiated from the second device is performed within the further time interval via a backhaul between the first device and the second device, determining the at least one further set of reference receiving powers as the at least one first set of measured receiving powers.

37. The method of claim 32, further comprising:
in accordance with a determination that a difference between the at least one set of reference receiving powers and the at least one set of actual receiving powers is below a threshold difference, updating the at least one set of reference receiving powers based on the at least one set of actual receiving powers.

38. The method of claim 32, wherein the at least one set of reference receiving powers comprise a set of reference receiving powers and the at least one set of actual receiving powers comprise a set of actual receiving powers, and the method further comprising:
generating a first curve based on the set of reference receiving powers;
generating a second curve based on the set of actual receiving powers;
determining at least one of the following as the difference:
a Euclidean distance between the first curve and the second curve;
a Chebyshev distance between the first curve and the second curve; and
a distance between the first curve and the second curve in a frequency domain.

39. The method of claim 32, wherein the at least one set of reference receiving powers comprise a set of reference receiving powers and a further set of reference receiving powers and the at least one set of actual receiving powers comprise a set of actual receiving powers and a further set of actual receiving powers, and the method further comprising:
generating a first set of curves based on the set of reference receiving powers and the further set of reference receiving powers;
generating a second set of curves based on the set of actual receiving powers and the further set of actual receiving powers; and
determining a spatial distance between the first set of curves and the second set of curves as the difference.

40. The method of claim 32, wherein the first device comprises an access point, and a second device comprises a further access point.

41. A non-transitory computer readable medium comprising program instructions for causing an apparatus to:
in accordance with a determination that an interference to the first device is to be detected, determine at least one set of actual receiving powers at the first device on a bandwidth and a frequency of a channel associated with a transmission of the first device within a time interval;
determine at least one set of reference receiving powers at the first device on the bandwidth and the frequency; and
in accordance with a determination that a difference between the at least one set of reference receiving powers and the at least one set of actual receiving powers exceeds a threshold difference, determine the first device is interfered by reactive jamming,
wherein determining at least one set of reference receiving powers comprises:
in accordance with a determination that there is a further transmission initiated from a second device within the time interval, determining at least one first set of measured receiving powers of the first device related to the further transmission;
determining at least one second set of measured receiving powers of the first device related to the self-interference of the first device; and
determining the at least one set of reference receiving powers based on the at least one first set of measured receiving powers and the at least one second set of measured receiving powers.

42. The non-transitory computer readable medium of claim 41, further comprising program instructions for causing the apparatus to:
transmit, to a second device, an indication for triggering a reference transmission initiated from the second device; and
receive an indication of a further time interval of the reference transmission from the second device;
measure at least one set of interfered receiving powers associated with the reference transmission within the further time interval; and
in accordance with a determination that the at least one set of receiving powers is in a range between thermal noise power and a clear channel assessment threshold, determine the at least one set of receiving powers as the at least one first set of measured receiving powers.
